(19) United States
(12) Patent Application Publication
(10) Pub. No.: US 2026/0006493 A1
(43) Pub. Date: Jan. 1, 2026

(54) A METHOD OF RESOURCE EFFICIENCY IMPROVEMENT

(71) Applicant: ZTE CORPORATION, Shenzhen, Guangdong (CN)

(72) Inventors: Xiubin SHA, Shenzhen (CN); Bo DAI, Shenzhen (CN); Yuan GAO, Shenzhen (CN); Ting LU, Shenzhen (CN)

(21) Appl. No.: 18/992,342

(22) PCT Filed: Jul. 8, 2022
(86) PCT No.: PCT/CN2022/104721

§ 371 Date: Jan. 8, 2025

(51) Int. Cl. H04W 28/06; H04L 1/1607; H04L 5/00

(52) U.S. Cl. CPC H04W 28/065; H04L 1/1642; H04L 5/0053

(57) ABSTRACT

This disclosure relates generally to a method, device, and system for efficiently coordinating resources among different entities in a wireless network. A service data unit (SDU) is received. The SDU is divided into a plurality of segments. The plurality of segments are transmitted to a receiving device. An acknowledgement of successful transmission of one or more of the plurality of segments is transmitted.

### CROSS-REFERENCE TO RELATED

The present disclosure is a national stage filing under 35 U.S.C. § 371 of international application number PCT/CN2022/104721, filed on Jul. 8, 2022, which is incorporated herein by reference in its entirety.

### TECHNICAL FIELD

This disclosure is directed generally to wireless communications, and particularly to a method, device, and system for efficiently coordinating resources among different entities in a wireless network.

### BACKGROUND

Present wireless communication networks suffer from a variety of drawbacks, limitations, and disadvantages. Accordingly, there is a need for inventive methods, devices, and systems described herein.

### SUMMARY

This disclosure is directed to a method, device, and system for improving coordination among different entities in a wireless network.

In some embodiments, a method for wireless communication, performed by a transmitting device in a wireless communication system includes receiving a service data unit (SDU); dividing the SDU into a plurality of segments; transmitting the plurality of segments to a receiving device; and transmitting an acknowledgement of successful transmission of one or more of the plurality of segments.

In some embodiments, a method for wireless communication, performed by a receiving device in a wireless communication system includes receiving a plurality of SDU segments from a transmitting device at a first entity of the receiving device; transmitting the plurality of SDU segments to one or more other receiving entities of the receiving device; transmitting an acknowledgement to the transmitting device in response to receiving a segment of the plurality of SDU segments; and assembling the plurality of SDU segments into a reassembled PDCP PDU having a PDCP header.

In some embodiments, there is a network element or a UE comprising a processor and a memory, wherein the processor is configured to read code from the memory and implement any methods recited in any of the embodiments.

In some embodiments, a computer program product comprising a computer-readable program medium code stored thereupon, the code, when executed by a processor, causing the processor to implement any method recited in any of the embodiments.

The above embodiments and other aspects and alternatives of their implementations are described in greater detail in the drawings, the descriptions, and the claims below.

### BRIEF DESCRIPTION OF THE DRAWINGS

FIG. 1 shows an example wireless communication network.

FIG. 2 shows an example wireless network node.

FIG. 3 shows an example user equipment.

FIG. 4 shows an example block diagram of a transmitting and receiving PDCP entity.

FIG. 5A shows an example PDCP PDU segment data format.

FIG. 5B shows an example PDCP PDU segment data format.

FIG. 5C shows an example PDCP PDU segment data format.

FIG. 5D shows an example PDCP PDU segment data format.

FIG. 6 shows an example block diagram of a data transmitting entity and a data receiving entity.

FIG. 7 shows an example block diagram of a data transmitting entity and a data receiving entity.

FIG. 8 shows an example block diagram of a data transmitting entity and a data receiving entity.

FIG. 9 shows an example block diagram of a data transmitting entity and a data receiving entity.

FIG. 10 shows an example block diagram of a data transmitting entity and a data receiving entity.

FIG. 11A shows an example parameter configuration.

FIG. 11B shows an example parameter configuration.

FIG. 11C shows an example parameter configuration.

### DETAILED DESCRIPTION

### Wireless Communication Network

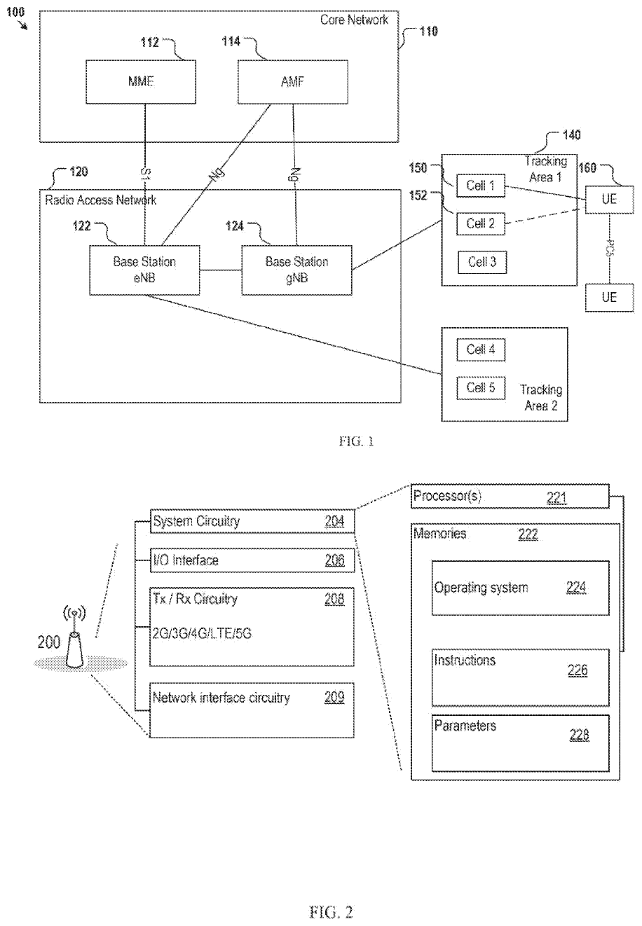

FIG. 1 shows an exemplary wireless communication network 100 that includes a core network 110 and a radio access network (RAN) 120. The core network 110 further includes at least one Mobility Management Entity (MME) 112 and/or at least one Access and Mobility Management Function (AMF). Other functions that may be included in the core network 110 are not shown in FIG. 1. The RAN 120 further includes multiple base stations, for example, base stations 122 and 124. The base stations may include at least one evolved NodeB (eNB) for 4G LTE, an enhanced LTE eNB (ng-eNB), or a Next generation NodeB (gNB) for 5G New Radio (NR), or any other type of signal transmitting/receiving device such as a UMTS NodeB. The eNB 122 communicates with the MME 112 via an S1 interface. Both the eNB 122 and gNB 124 may connect to the AMF 114 via an Ng interface. Each base station manages and supports at least one cell. For example, the base station gNB 124 may be configured to manage and support cell 1, cell 2, and cell 3.

The gNB 124 may include a central unit (CU) and at least one distributed unit (DU). The CU and the DU may be co-located in a same location, or they may be split in different locations. The CU and the DU may be connected via an F1 interface. Alternatively, for an eNB which is capable of connecting to the 5G network, it may also be similarly divided into a CU and at least one DU, referred to as ng-eNB-CU and ng-eNB-DU, respectively. The ng-eNB-CU and the ng-eNB-DU may be connected via a W1 interface.

The wireless communication network 100 may include one or more tracking areas. A tracking area may include a set of cells managed by at least one base station. For example, tracking area 1 labeled as 140 includes cell 1, cell 2, and cell 3, and may further include more cells that may be managed by other base stations and not shown in FIG. 1. The wireless communication network 100 may also include at least one UE 160. The UE may select a cell among multiple cells supported by a base station to communication with the base station through Over the Air (OTA) radio communication interfaces and resources, and when the UE 160 travels in the wireless communication network 100, it may reselect a cell for communications. For example, the UE 160 may initially select cell 1 to communicate with base station 124, and it may then reselect cell 2 at certain later time point. The cell selection or reselection by the UE 160 may be based on wireless signal strength/quality in the various cells and other factors.

The wireless communication network 100 may be implemented as, for example, a 2G, 3G, 4G/LTE, or 5G cellular communication network. Correspondingly, the base stations 122 and 124 may be implemented as a 2G base station, a 3G NodeB, an LTE eNB, or a 5G NR gNB. The UE 160 may be implemented as mobile or fixed communication devices which are capable of accessing the wireless communication network 100. The UE 160 may include but is not limited to mobile phones, laptop computers, tablets, personal digital assistants, wearable devices, Internet of Things (IoT) devices, MTC/eMTC devices, distributed remote sensor devices, roadside assistant equipment, XR devices, and desktop computers. The UE 160 may also be generally referred to as a wireless communication device, or a wireless terminal. The UE 160 may support sidelink communication to another UE via a PC5 interface.

While the description below focuses on cellular wireless communication systems as shown in FIG. 1, the underlying principles are applicable to other types of wireless communication systems for paging wireless devices. These other wireless systems may include but are not limited to Wi-Fi, Bluetooth, ZigBee, and WiMax networks.

FIG. 2 shows an example of electronic device 200 to implement a network base station (e.g., a radio access network node), a core network (CN), and/or an operation and maintenance (OAM). Optionally in one implementation, the example electronic device 200 may include radio transmitting/receiving (Tx/Rx) circuitry 208 to transmit/receive communication with UEs and/or other base stations. Optionally in one implementation, the electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

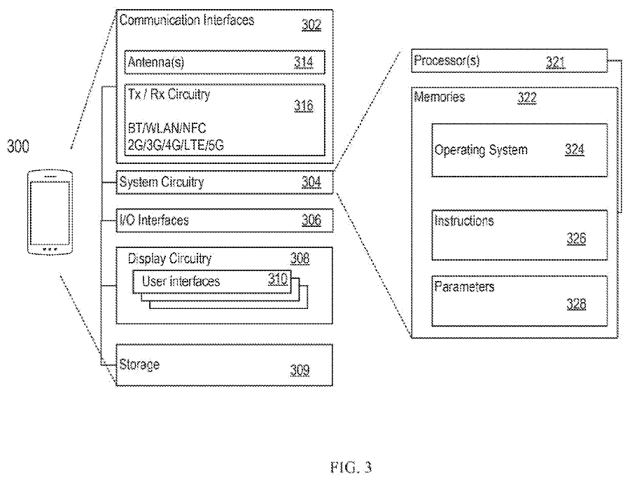

FIG. 3 shows an example of an electronic device to implement a terminal device 300 (for example, a user equipment (UE)). The UE 300 may be a mobile device, for example, a smart phone or a mobile communication module disposed in a vehicle. The UE 300 may include a portion or all of the following: communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

### Resource Efficiency Improvement

Based on the current 3GPP specification, the size of one packet data convergence protocol (PDCP) packet data unit (PDU) may be sized to a maximum of 9000 bytes, and the PDU may not be segmented in a PDCP entity. Extended reality (XR) service may utilize larger PDCP PDUs, which may be segmented in a radio link control (RLC) RLC entity. Thus, in the case of PDCP duplication, a whole PDCP PDU may be transmitted to multiple RLC entities and segmented by each RLC entity individually. When all of the segments in one RLC entity are transmitted successfully, the RLC entity may acknowledge the transmission of the PDCP PDU and the PDCP entity shall indicate to the other RLC entity/entities to discard it. Under the current 3GPP specification, no communication occurs between RLC entities. Thus, a frequency diversity gain from multiple RLC paths may not be obtained in these cases. Therefore, some of the segments may be transmitted successfully in one RLC entity and other segments may be transmitted successfully in another RLC entity; however, the successfully transmitted segments in different RLC entities cannot be concatenated. Accordingly, methods, devices, and systems are disclosed in accordance with the present subject matter to implement cooperation between different RLC entities, different MAC entities and/or different PHY entities in the case of data duplication case.

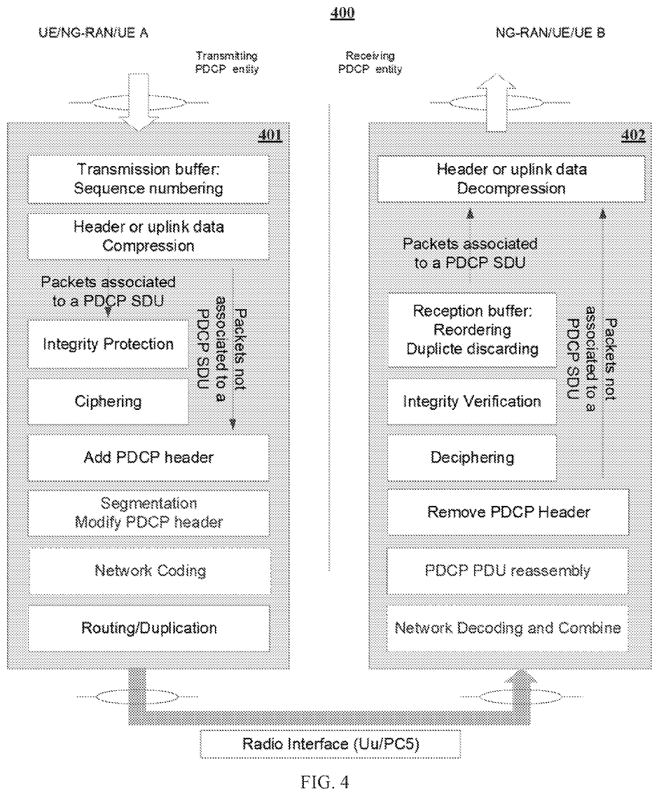

Referring to FIG. 4, an example transmitting PDCP entity 401 and a receiving PDCP entity 402 are shown. In this example, segmentation may be introduced in the transmitting PDCP entity 401, and PDCP PDU reassembly may be introduced by the receiving PDCP entity 402. When the segmentation occurs only for data and MAC-I fields, for example, each segment of the segmentation may include: a PDCP header and a corresponding segment of a data field, a PDCP header, a segment of a data field, and a segment of a MAC-I field; or a PDCP header and a segment of a MAC-I field.

Upon reception of the service data unit (SDU) in the transmitting PDCP entity 401, the PDCP header may be added to the SDU. The transmitting PDCP entity 401 may divide the corresponding PDCP PDU into several segments and send them to one or more RLC entities. However, before sending the segments to the one or more RLC entities, network coding may be performed for each segment.

Upon successful reception of one segment, one of the following procedures may be performed: (1) the receiving RLC entity may deliver the segments to the receiving PDCP entity 402. The receiving PDCP entity 402 may send a PDCP acknowledge indication to the transmitting PDCP entity 401. The transmitting PDCP entity 401 may then instruct the transmitting RLC entity/entities to discard the received segment of the PDCP PDU; (2) the receiving RLC entity may send an RLC acknowledge indication to the transmitting RLC entity. The transmitting RLC entity may acknowledge the segment transmission of the PDCP PDU. The transmitting PDCP entity 401 may then instruct the other remaining transmitting RLC entity/entities to discard the received segment of the PDCP PDU; (3) the receiving RLC entity may send an RLC acknowledge indication to the transmitting RLC entity. The transmitting RLC entity may then instruct the other remaining transmitting RLC entity/entities to discard the received segment of the PDCP PDU.

If network coding is performed in the transmitting PDCP entity 401, the PDCP PDUs may be decoded and combined in the receiving PDCP entity 402.

After receiving all of the segments of the PDCP PDU, reassembly may be performed by the receiving PDCP entity 402. During reassembly, the PDCP header may be restored, which may include removing the PDCP segment field, by resetting a 2-bit segmentation info (SI) field within a PDCP PDU to “00,” and removing a segment sequence number (SSN) field and/or a segment offset (SO) field. Reassembly may further include concatenating the data and MAC-I fields in sequence based on the SSN and/or SO field(s).

Alternatively, or in addition, the RLC SDU segment(s) may be only transmitted from one transmitting RLC entity to one receiving RLC entity. The RLC entity may be the primary RLC entity or may be an RLC entity selected according to radio quality (e.g. RSRP value, CQI, etc.) or cell load information. Once transmission failure occurs, PDCP duplication may be triggered, and the RLC SDU segment(s) may be transmitted or retransmitted from more than one transmitting RLC entity to more than one receiving RLC entity.

Alternatively, or in addition, the RLC SDU segment(s) may be transmitted from a first set of transmitting RLC entities to a first set of receiving RLC entities. Once transmission failure occurs, the RLC SDU segment(s) may be transmitted or retransmitted from a second set of transmitting RLC entities to a second set of receiving RLC entities.

The first and second set of RLC entities may be configured by the network, and the second set of RLC entities may provide better quality of service (QoS) or higher reliability than that of the first set of RLC entities; e.g., the second set of RLC entities may have more RLC entities than the first set of RLC entities.

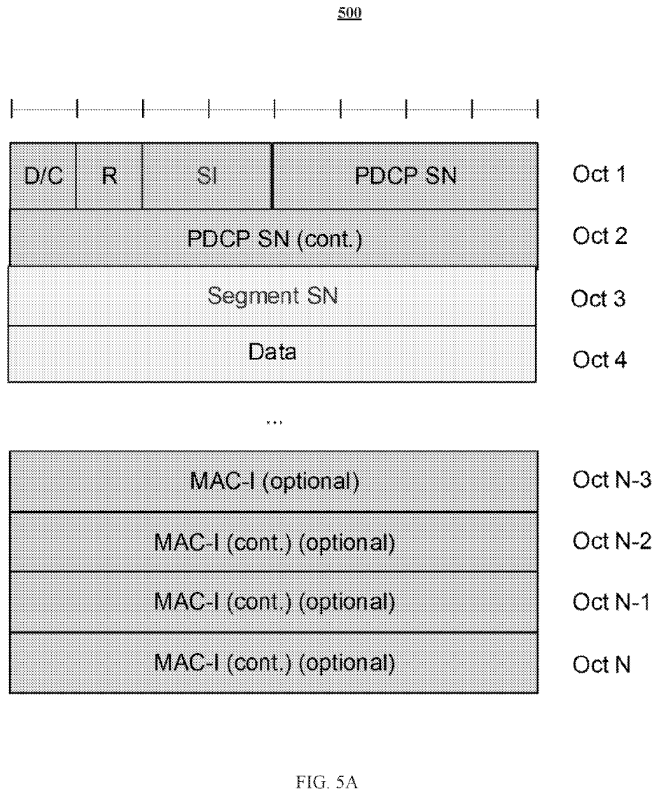

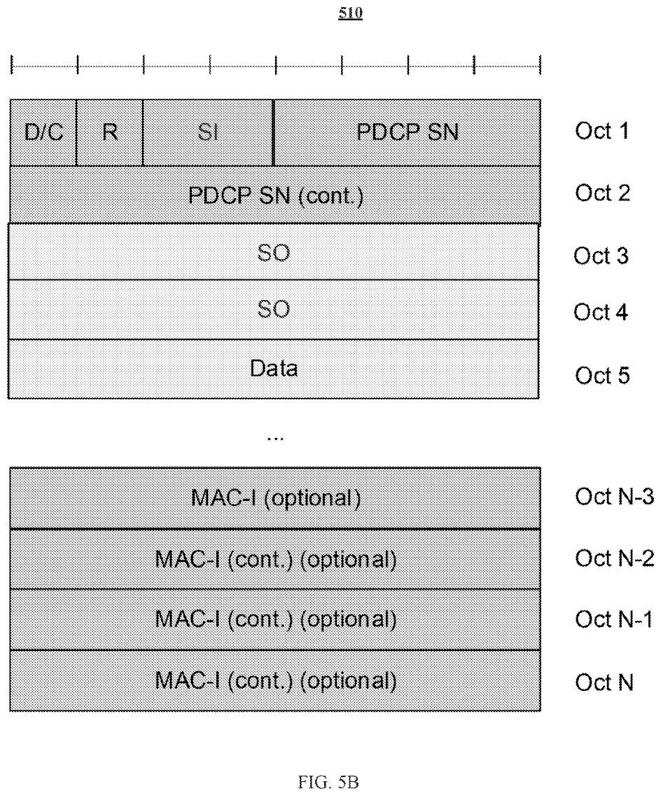

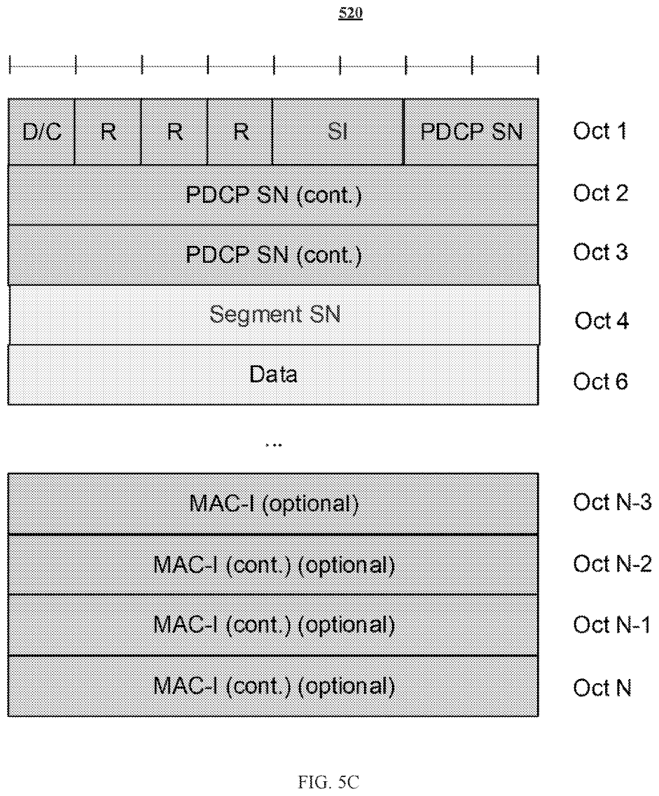

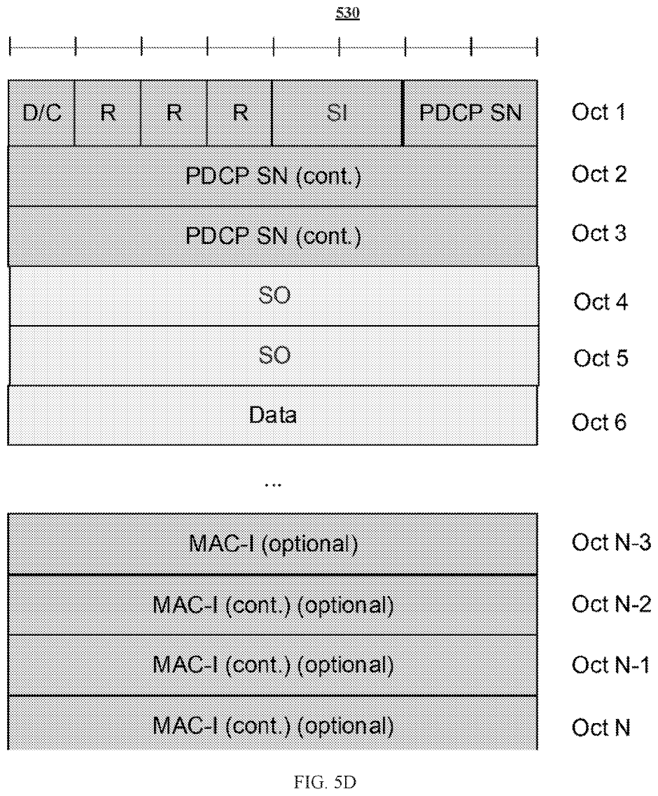

As previously referenced, where the PDCP PDU is reassembled in the receiving PDCP entity 402 from a plurality of PDCP PDU segments, the SI field and/or SO field(s) may be introduced into the PDCP PDU segment data format as shown with reference to FIGS. 5A-5D. In FIG. 5A, an example PDCP PDU segment data format 500 with a 12-bit PDCP SN and a 2-bit SI is shown. In FIG. 5B, an example PDCP data PDU format 510 with a 12-bit PDCP SN, 2-bit SI, and 16-bit SO is shown. In FIG. 5C, an example PDCP PDU segment data format 520 with an 18-bit PDCP SN and 2-bit SI is shown. In FIG. 5D, an example PDCP PDU segment data format 530 with an 18-bit PDCP SN, 2-bit SI, and 16-bit SO is shown.

The SI field may be defined as a 2-bit field that indicates whether a PDCP PDU contains a complete PDCP PDU or rather, the first, middle, or last segment(s) of the PDCP PDU according to the values provided in Table 1.

TABLE 1

| SI | |
|---|---|
| field | |
| value | Description |
| 00 | Data field contains all bytes of data and MAC-I in a |
| | PDPC PDU |
| 01 | Data field contains the first segment of data and MAC-I |
| | in a PDCP PDU |
| 10 | Data field contains the last segment of data and MAC-I |
| | in a PDCP PDU |
| 11 | Data field contains neither the first nor last segment(s) of |
| | data and MAC-I in a PDCP PDU |

The SSN field may indicate the sequence number of a segment of a segmented PDCP PDU.

The SSN field may be encoded with a consecutive integer number starting at zero or one (e.g., 0, 1, 2, 3, or 1, 2, 3 . . . ).

The SO field may indicate the position of a segment of the segmented PDCP PDU in bytes within the original PDCP PDU. Specifically, the SO field may indicate the position within the original PDCP PDU to which the first byte of the PDCP PDU segment in the data field corresponds. The first byte of the original PDCP PDU may be referred to by the SO field value “0000000000000000,” where the numbering starts at zero, for example. The SO field length may be eight bits, for example, or other bit lengths, as shown with reference to FIGS. 5B and 5D.

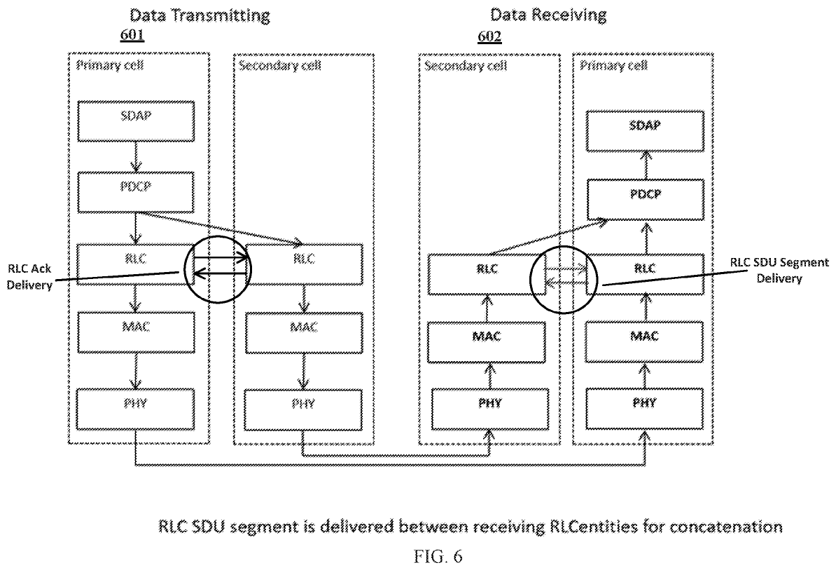

Referring to FIG. 6, the RLC SDU may be segmented in each transmitting RLC entity and each transmitting RLC entity may send the RLC SDU segments to the corresponding receiving RLC entity/entities. Interaction between receiving RLC entities may be supported such that a receiving RLC entity of a data receiving entity 602 may receive one or more RLC PDU(s) from one or more other RLC entities of a data transmitting entity 601. The RLC SDU segments from different RLC entities may be concatenated or combined in the receiving RLC entity of the data receiving entity 602 with an increased concatenation success rate and a decreased RLC retransmission rate. In this example, for the same RLC SDU, the SN of the RLC PDU in different RLC entities should be the same (e.g., the SN of the RLC PDU is set to the SN of the RLC SDU). The receiving RLC entity of the data receiving entity 602 may deliver the RLC SDU segment received successfully to one or more other RLC entity/entities when PDCP duplication is activated.

When a segment in one RLC entity are transmitted successfully, the receiving RLC entity may acknowledge the transmission of the RLC PDU to the transmitting RLC entity, and the transmitting RLC entity may deliver the RLC acknowledgement to one or more other transmitting RLC entity/entities to discard the RLC SDU segment or to stop the RLC SDU segment retransmission.

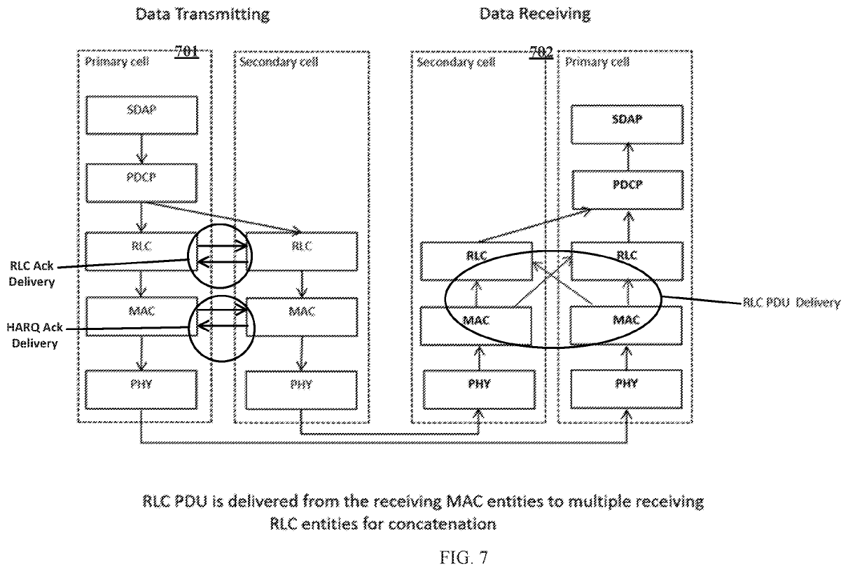

Referring to FIG. 7, the RLC SDU may be segmented in each transmitting RLC entity and each transmitting RLC entity may send the RLC SDU segments to the corresponding receiving RLC entity. Interaction between receiving MAC entities and multiple receiving RLC entities of a data receiving entity 702 may be supported such that RLC SDU segments from different transmitting RLC entities may be concatenated or combined in the receiving RLC entity of the data receiving entity 702. In this example, for the same RLC SDU, the SN of an RLC PDU in different RLC entities should be the same (e.g., the SN of the RLC PDU is set to the SN of the RLC SDU). The receiving MAC entity of the data receiving entity 702 may deliver the RLC SDU segment(s) received successfully to the multiple RLC entity/entities when PDCP duplication is activated either delivered directly or delivered via the PDCP entity).

For concatenation or combination of the segments in the receiving RLC entities, one of the following operations may be performed. In a first option, the PDCP entity may indicate a pre-defined RLC segment length to the RLC entity, and the RLC entity may perform the segment based on the indicated pre-defined length. This option may allow for RLC segments to be concatenated simply. In a second option, the segment length may be determined by each RLC entity. The RLC entity may combine the RLC PDU to the RLC SDU based on the SI/SN/SO fields. In some cases, the RLC PDU fields may overlap with different lengths, so the receiving RLC entity should combine them byte by byte. With this option, the RLC SDU segments may be combined based on the SN/SI/SO field in the RLC PDU. For example, when based on the SO field, the receiving RLC can know the RLC PDU received successfully corresponds to which bytes in the RLC SDU.

Based on the interaction between receiving RLC entities, only the RLC SDU segments that are not received successfully after concatenation or combination of the PDUs from all of the RLC entities may be triggered to retransmit (i.e., an RLC NAK is sent to the transmitting RLC entity).

Based on the foregoing description, the RLC entities may be capable of inter-operating with one another. For instance, once a segment is received successfully by a receiving RLC entity, it may be directly delivered to other receiving RLC entities or delivered to a primary entity or forwarded indirectly by the PDCP entity. Therefore, RLC SDU segments from different RLC entities may be concatenated or combined, and only the RLC SDU segments that are not received by any RLC entity should be retransmitted. That is, if the RLC SDU segment(s) from one RLC entity are transmitted successfully, the RLC entity may indicate to the other RLC entity/entities to stop retransmitting it by sending the RLC segment information or sending an indication in a status packet. Thus, the transmission efficiency may be improved and the transmission delay may be decreased.

The SN, SI, and SO fields are defined in 3GPP TS 38.322 as follows. The SN field may have a configurable length of 12 bits or 18 bits for an AMD PDU. The SN field may have a configurable length of 6 bits or 12 bits for a UMD PDU. The SN field may indicate the sequence number of the corresponding RLC SDU. For RLC AM, the sequence number may be incremented by one for every RLC SDU. For RLC UM, the sequence number may be incremented by one for every segmented RLC SDU.

The SI field may have a length of 2 bits. The SI field may indicate whether an RLC PDU contains a complete RLC SDU or the first, middle, or last segment of an RLC SDU according to the values provided in Table 2 below.

TABLE 2

| SI | |
|---|---|
| field | |
| value | Description |
| 00 | Data field contains all bytes of an RLC SDU |
| 01 | Data field contains the first segment of an RLC SDU |
| 10 | Data field contains the last segment of an RLC SDU |
| 11 | Data field contains neither the first nor last segment |
| | of an RLC SDU |

The SO field may have a length of 16 bits. The SO field may indicate the position of the RLC SDU segment in bytes within the original RLC SDU. Specifically, the SO field may indicate the position within the original RLC SDU to which the first byte of the RLC SDU segment in the Data field corresponds. The first byte of the original RLC SDU may be referred by the SO field value “0000000000000000”, i.e., numbering starts at zero.

When a MAC SDU in one RLC entity are transmitted successfully, the receiving MAC entity may acknowledge (e.g., HARQ acknowledgement) the transmission of the MAC PDU to the transmitting MAC entity, and the transmitting MAC entity may deliver the HARQ acknowledgement to one or more other transmitting MAC entity/entities to discard the MAC SDU or to stop the MAC SDU retransmission.

Alternatively, or in addition, when a segment in one RLC entity are transmitted successfully, the receiving RLC entity may acknowledge the transmission of the RLC PDU (e.g., RLC ARQ) to the transmitting RLC entity, and the transmitting RLC entity may deliver the RLC acknowledgement to one or more other transmitting RLC entity/entities to discard the RLC SDU segment or to stop the RLC SDU segment retransmission.

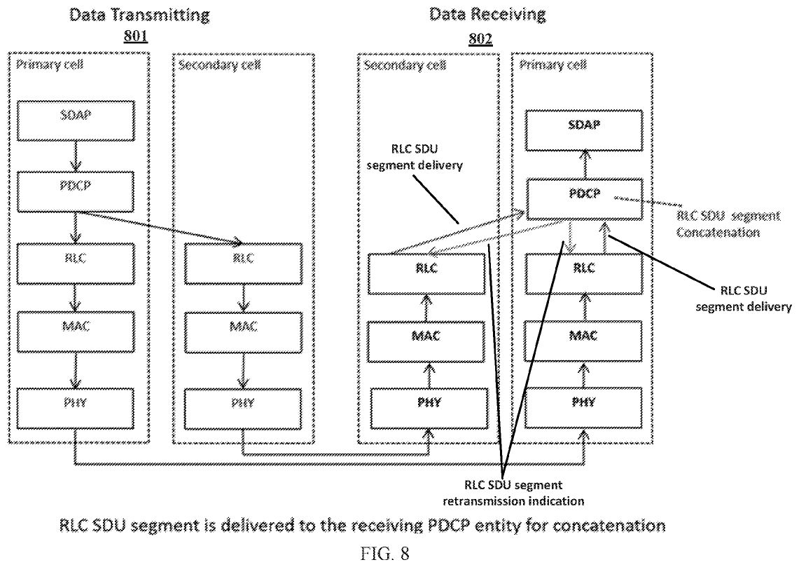

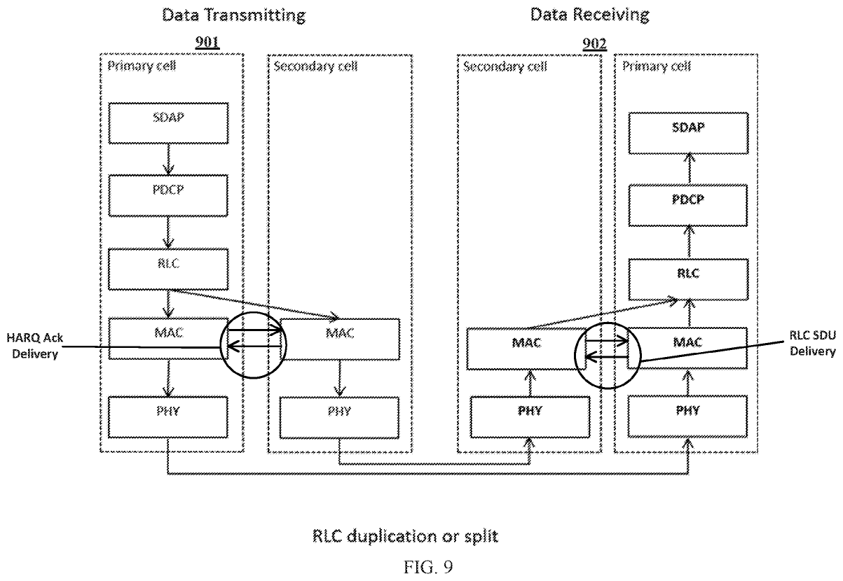

Referring to FIG. 8, a receiving RLC entity of a data receiving entity 802 may send the RLC SDU segment to a receiving RLC PDCP entity of the data receiving entity 802. The receiving PDCP entity may perform the RLC SDU segment concatenation or combination. The receiving PDCP entity of the data receiving entity 802 may indicate to the receiving RLC entities to retransmit the RLC SDU segments that are unsuccessfully received. In this example, for the same RLC SDU, the SN of the RLC PDU in different RLC entities should be the same (e.g., the SN of the RLC PDU is set to the SN of the RLC SDU).

For concatenation or combination in the receiving PDCP entity of the data receiving entity 802, one of the following options may be performed. In a first option, the PDCP entity may indicate the pre-defined RLC segment length to the RLC entity, and the RLC entity may perform the segment based on the indicated length. This option may allow RLC segments to be concatenated simply. In a second option, the segment length may be determined by each RLC entity. The RLC entity may combine the RLC PDU to the RLC SDU based on the SI/SN/SO fields. In some cases, the RLC PDU fields may overlap with different lengths, so the receiving RLC entity should combine them byte by byte. With this option, the RLC SDU segments may be combined based on the SN/SI/SO field in the RLC PDU. For example, when based on the SO field, the receiving RLC can know the RLC PDU received successfully corresponds to which bytes in the RLC SDU.

Referring to FIG. 9, a data duplication or split may be performed in the RLC layer. That is, the transmitting RLC entity of a data transmitting entity 901 may send the RLC PDU duplicates to multiple MAC entities of the data transmitting entity 901, which correspond to multiple cells, to transmit more reliably. This may occur before RLC PDU duplicates are sent, and/or network coding can be performed.

Alternatively, or in addition, the transmitting RLC entity of the data transmitting entity 901 may split the RLC PDUs into multiple groups and may send the multiple groups of RLC PDUs separately to multiple MAC entities corresponding multiple cells to transmit for higher throughput.

Upon reception of the RLC PDUs from multiple receiving MAC entities corresponding multiple cells, the receiving RLC entity of the data receiving entity 902 may concatenates or combines them into an RLC SDU. Only if the RLC PDU is not received successfully by all MAC entities, the RLC PDU retransmission may be triggered.

If network coding is performed in the transmitting RLC entity of the data transmitting entity 901, network decoding may be performed for the RLC PDUs in the receiving RLC entity, and then combined in the RLC entity of the data receiving entity 902.

The RLC status PDU may be sent by the primary MAC entity, or by any one of the MAC entities. In this case, since the RLC PDUs may be concatenated or combined in the same RLC entities, frequency diversity gain from multiple data paths may be improved. That is, if an RLC SDU segment is transmitted successfully to the receiving RLC entity from any one of the MAC entities, it may be received successfully and may be used for RLC SDU concatenating or combining.

When a MAC PDU is received successfully, the receiving MAC entity may send it to one or more other receiving MAC entities when RLC duplication is activated (either delivered directly or delivered via an RLC entity) to stop HARQ retransmission.

When a MAC PDU is received successfully, the receiving MAC entity may acknowledge (e.g., HARQ acknowledgement) the transmission of the MAC PDU to the transmitting MAC entity, and the transmitting MAC entity may deliver the HARQ acknowledgement to one or more other transmitting MAC entity/entities to discard the MAC SDU or to stop the MAC SDU retransmission.

Alternatively, or in addition, the RLC SDU segment(s) may only be transmitted from one transmitting MAC entity to one receiving MAC entity. The MAC entity may be a primary MAC entity or a MAC entity selected according to radio quality (e.g., RSRP value, CQI etc.) or cell load information. Once transmission failure occurs, RLC duplication may be triggered, and the RLC SDU segment(s) may be transmitted or retransmitted from more than lone transmitting MAC entities to more than one receiving MAC entities.

Alternatively, or in addition, the RLC SDU segment(s) are transmitted from a first set of transmitting MAC entities to a first set of receiving MAC entities. Once transmission failure occurs, the RLC SDU segment(s) may be transmitted or retransmitted from a second set of transmitting MAC entities to a second set of receiving MAC entities.

The first and second set of MAC entities may be configured by the network, and the second set of MAC entities may provide better QoS or higher reliability than the first set of MAC entities; e.g., the second set of MAC entities may have more MAC entities than the first set of MAC entities.

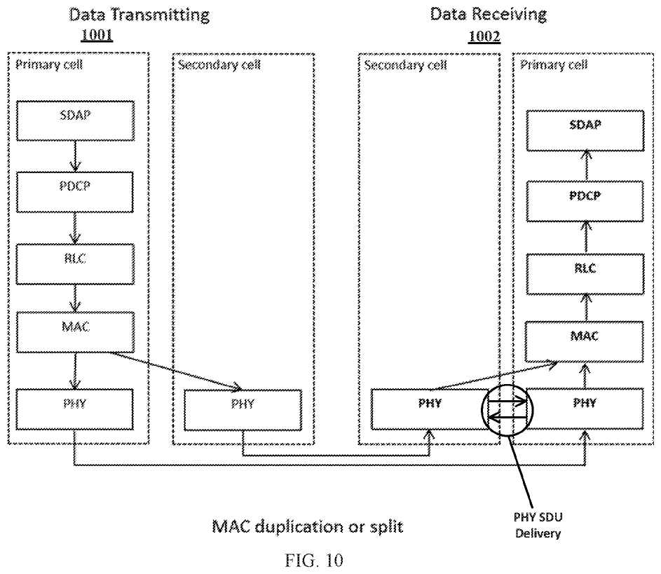

Referring to FIG. 10, data duplication or split may be performed in the MAC layer. That is, the transmitting MAC entity of a data transmitting entity 1001 may send the MAC PDU duplicates to multiple physical (PHY) entities corresponding to multiple cells to transmit more reliably. This may occur before MAC PDU duplicates are sent and/or network coding can be performed. Upon receiving a MAC PDU with a same LC-ID, same SN, or PDU IDs from different MAC entities, the receiving MAC entity of the data receiving entity 1002 may concatenate or combine them into a MAC SDU.

Alternatively, or in addition, the transmitting MAC entity of the data transmitting entity 1001 may split the MAC PDUs into multiple groups and may send the multiple groups of MAC PDUs separately to multiple PHY entities corresponding to multiple cells for higher throughput.

If network coding is performed in the transmitting MAC entity of the data transmitting entity 1001, network decoding may be performed for the MAC PDUs and then combined in the receiving MAC entity of the data receiving entity 1002.

When a MAC PDU is received successfully, the receiving PHY entity may send it to one or more other receiving PHY entities when MAC duplication is activated for soft combination.

When any one of the PHY entities decoding the MAC PDU successfully, the receiving MAC entities will send a HARQ acknowledgment to the transmitting MAC entities to stop retransmission. The HARQ ACK/NACK may be sent by the primary PHY entity or by any one of the other PHY entities of one or more cells. That is, if a MAC PDU is transmitted successfully to any of the receiving PHY entities of the data receiving entity 1002, it may be received successfully and may increase the frequency diversity gain.

Alternatively, the MAC PDU may only be transmitted from one transmitting PHY entity to one receiving PHY entity. The PHY entity may be a primary PHY entity, or a PHY entity selected according to radio quality (e.g., RSRP value, CQI, etc.) or cell load information. Once transmission failure occurs, MAC duplication may be triggered, and the MAC PDU may be transmitted or retransmitted from more than one transmitting PHY entities to more than one receiving PHY entities.

Alternatively, or in addition, the MAC PDU may be transmitted from a first set of transmitting PHY entities to a first set of receiving PHY entities. Once transmission failure occurs, the MAC PDU may be transmitted or retransmitted from a second set of transmitting PHY entities to a second set of receiving PHY entities.

The first and second set of PHY entities may be configured by the network, and the second set of PHY entities may provide better QoS or higher reliability than that of the first set of PHY entities; e.g., the second set of PHY entities may have more PHY entities than the first set of PHY entities.

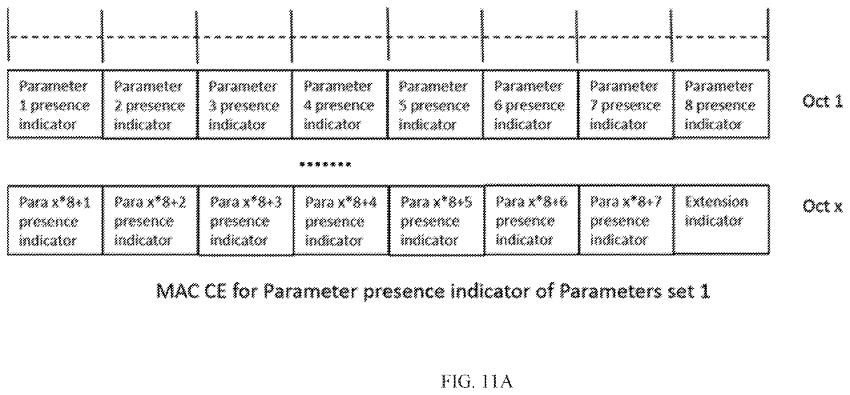

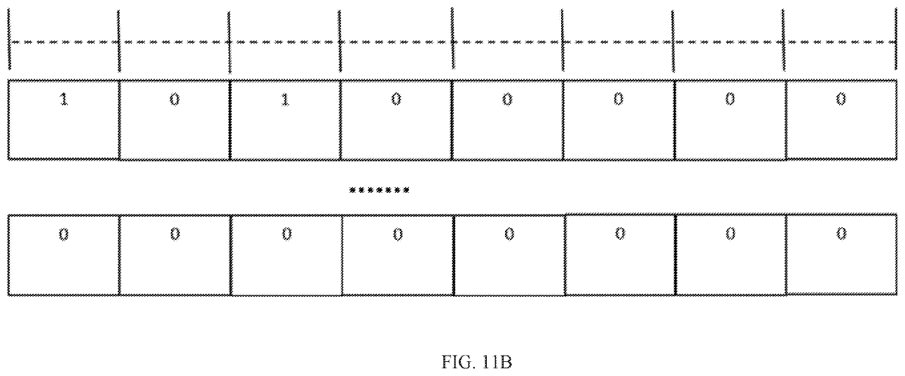

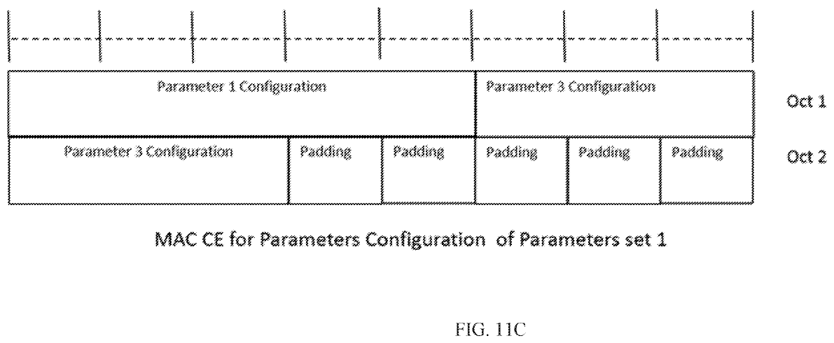

Referring to FIGS. 11A-11C, an example parameter configuration by the MAC control element (CE) is provided. A first MAC CE (e.g., FIG. 11A) may be used to identify a parameter set that indicates the presence of each parameter included in the parameter set. A second MAC CE (e.g., FIG. 11B) corresponding to the first MAC CE may include the configuration for each parameter, which may include one or more of the configurations for parameters. Based on this mode, one or more level of MAC CE structure may be defined; e.g., if the n^{th} MAC CE indicates whether a parameter or a group of parameters is present, and the (n+1)^{th} level MAC CE provide the related configuration, if present.

In FIG. 11A, at most x*8+7 parameters may be included in the Parameter Set 1. Each bit of the MAC CE may indicate whether a parameter is present or absent in the corresponding MAC CE for the parameter configuration. That is, a set bit (“1”) may indicate the parameter is present while an unset bit (“0”) may indicate the parameter is absent. The last bit of the MAC CE may be used as an extension indicator. The default value of the extension indicator may be “0,” where a value of “1” indicates an additional Octet may be appended to the MAC CE for indicating additional parameters may be present.

The MAC CE parameter presence indicator of the Parameter Set 1 shown in FIG. TTA may be identified by LC-ID or by a higher level MAC CE. A higher level MAC CE may be used to indicate whether the MAC CE for the parameter presence indicator of the parameter set x shown in FIG. TA is followed, where x=1, . . . n.

Referring to FIG. 11B, parameters may be included in the Parameter Set 1. That is, only parameter 1 and parameter 3 are present as indicated in the example of FIG. 11B.

Referring to FIG. 11C, as indicated by FIG. 11B (the first level MAC CE), only parameter 1 and parameter 3 are present; as indicated by FIG. 11B (the first level MAC CE), only parameter 1 and parameter 3 are present. Supposing that parameter 1 may be defined as having a length of 5 bits while parameter 3 may be defined as having a length of 6 bits, then the parameter 1 and parameter 3 configuration are included in the second level MAC CE for parameter configuration in sequence. A padding bit may be used for Octet (i.e., 8 bit) alignment as shown in FIG. 11C.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution may be practiced without one or more of the specific features or advantages of a particular embodiment. In other instances, additional features and advantages may be recognized in certain embodiments that may not be present in all embodiments of the present solution.

The subject matter of the disclosure may also relate to or include, among others, the following aspects:

A first aspect includes a method for wireless communication, performed by a transmitting device in a wireless communication system including: receiving a service data unit (SDU); dividing the SDU into a plurality of segments; transmitting the plurality of segments to a receiving device; and transmitting an acknowledgement of successful transmission of one or more of the plurality of segments.

A second aspect includes the method of the first aspect further including: performing network coding for each of the plurality of segments.

A third aspect includes a method for wireless communication, performed by a receiving device in a wireless communication system including: receiving a plurality of SDU segments from a transmitting device at a first entity of the receiving device; transmitting the plurality of SDU segments to one or more other receiving entities of the receiving device; transmitting an acknowledgement to the transmitting device in response to receiving a segment of the plurality of SDU segments; and assembling the plurality of SDU segments into a reassembled PDCP PDU having a PDCP header.

A fourth aspect includes the method of any preceding aspect, wherein the plurality of SDU segments are received from the transmitting device by a radio link control (RLC) entity of a plurality of RLC entities.

A fifth aspect includes the method of any preceding aspect, further including delivering the plurality of SDU segments to a PDCP entity.

A sixth aspect includes the method of any preceding aspect, wherein the acknowledgement is sent from a PDCP entity of the receiving device.

A seventh aspect includes the method of any preceding aspect, wherein the acknowledge indication is sent from the RLC entity.

An eighth aspect includes the method of any preceding aspect, further including receiving a PDCP acknowledge indication from a receiving PDCP entity of the receiving device that indicates a segment of the plurality of transmitted segments has been successfully received; and instructing a transmitting RLC entity of the transmitting device to discard the successfully received segment.

A ninth aspect includes the method of any preceding aspect, further including removing a PDCP segment field by resetting a segmentation info field of the reassembled PDCP PDU; and
removing a segment sequence number (SSN) field, or removing a segment offset (SO) field.

A tenth aspect includes the method of any preceding aspect, further including concatenating data field and a MAC-I field of the reassembled PDCP PDU in sequence based on a segment sequence number (SSN) field and/or a segment offset (SO) field.

An eleventh aspect includes the method of any preceding aspect, wherein each of the plurality of SDU segments include a consecutively numbered segment sequence number (SSN) field; and the plurality of SDU segments are reassembled according to the segment sequence number.

A twelfth aspect includes the method of any preceding aspect, wherein the plurality of SDU segments are reassembled according to a segment offset field contained within that indicates a position of the segment within an original unsegmented SDU.

A thirteenth aspect includes the method of any preceding aspect, wherein the plurality of SDU segments are received from multiple medium access control (MAC) entities and communicated between a plurality of radio link control (RLC) entities of the receiving device and combined or concatenated in a receiving RLC entity of the receiving device.

A fourteenth aspect includes the method of any preceding aspect, wherein the plurality of SDU segments are received from a plurality of different transmitting RLC entities of the transmitting device and combined or concatenated in a receiving RLC entity of the receiving device.

A fifteenth aspect includes the method of any preceding aspect, wherein the plurality of SDU segments are combined or concatenated based on a pre-defined RLC segment length.

A sixteenth aspect includes the method of any preceding aspect, wherein the plurality of SDU segments are combined or concatenated based on: a segment offset field contained within that indicates a position of the segment within an original unsegmented SDU.

A seventeenth aspect includes the method of any preceding aspect, wherein each of the plurality of SDU segments include a consecutively numbered segment sequence number (SSN) field; and the plurality of SDU segments are combined or concatenated according to the segment sequence number.

An eighteenth aspect includes the method of any preceding aspect, further including transmitting a retransmit indication to a radio link control (RLC) entity of the receiving device from a PDCP entity of the receiving device in response to unsuccessfully receiving an RLC service data unit (SDU) from the RLC entity.

A nineteenth aspect includes the method of any preceding aspect, wherein the plurality of SDU segments are received from a plurality of different RLC entities and combined or concatenated in a receiving PDCP entity of the receiving device.

A twentieth aspect includes the method of any preceding aspect, wherein the plurality of SDU segments are combined or concatenated based on a pre-defined RLC segment length.

A twenty-first aspect includes the method of any preceding aspect, wherein the plurality of SDU segments are combined or concatenated based on: a segment offset field contained within that indicates a position of the segment within an original unsegmented SDU.

A twenty-second aspect includes the method of any preceding aspect, wherein each of the plurality of SDU segments include a consecutively numbered segment sequence number (SSN) field; and the plurality of SDU segments are combined or concatenated according to the segment sequence number.

A twenty-third aspect includes the method of any preceding aspect, wherein the SDU is an original SDU; and the method further comprises: duplicating the original SDU; and sending the original SDU and the duplicated SDU to a plurality of medium access control (MAC) entities corresponding to a plurality of cells of the transmitting device.

A twenty-fourth aspect includes the method of any preceding aspect, wherein the SDU is an original SDU; and the method further comprises: splitting the original SDU into a first PDCP group and a second PDCP group; and sending the first and second PDCP groups to corresponding first and second medium access control (MAC) entities corresponding to a plurality of cells of the transmitting device.

A twenty-fifth aspect includes the method of any preceding aspect, wherein the SDU is an original SDU; and the method further comprises: duplicating the original SDU; and sending the original SDU and the duplicated SDU to a plurality of physical (PHY) entities corresponding to a plurality of cells of the transmitting device.

A twenty-sixth aspect includes the method of any preceding aspect, wherein the SDU is an original SDU; and the method further comprises: splitting the original SDU into a first PDCP group and a second PDCP group; and sending the first and second PDCP groups to corresponding first and second physical (PHY) entities corresponding to a plurality of cells of the transmitting device.

A twenty-seventh aspect includes a device for wireless communication comprising a processor; and a memory in communication with the processor, the memory storing a plurality of instructions executable by the processor to cause the device to implement a method according to any preceding aspect.

A twenty-eighth aspect includes a non-transitory computer-readable medium comprising instructions operable, when executed by one or more processors, to implement a method according to aspects 1-26.

1. A method for wireless communication, performed by a transmitting device in a wireless communication system, the method comprising:
receiving a service data unit (SDU);
dividing the SDU into a plurality of segments;
transmitting the plurality of segments to a receiving device; and
transmitting an acknowledgement of successful transmission of one or more of the plurality of segments.

2. The method of claim 1, further comprising:
performing network coding for each of the plurality of segments.

3. A method for wireless communication, performed by a receiving device in a wireless communication system, the method comprising:
receiving a plurality of SDU segments from a transmitting device at a first entity of the receiving device;
transmitting the plurality of SDU segments to one or more other receiving entities of the receiving device;
transmitting an acknowledgement to the transmitting device in response to receiving a segment of the plurality of SDU segments; and
assembling the plurality of SDU segments into a reassembled PDCP PDU having a PDCP header.

4. The method of claim 3, wherein
the plurality of SDU segments are received from the transmitting device by a radio link control (RLC) entity of a plurality of RLC entities; or
the acknowledgement is sent from a PDCP entity of the receiving device; or
the acknowledge indication is sent from the RLC entity.

5. The method of claim 3, further comprising:
delivering the plurality of SDU segments to a PDCP entity.

6. (canceled)

7. (canceled)

8. The method of claim 1, further comprising:
receiving a PDCP acknowledge indication from a receiving PDCP entity of the receiving device that indicates a segment of the plurality of transmitted segments has been successfully received; and
instructing a transmitting RLC entity of the transmitting device to discard the successfully received segment.

9. The method of claim 3, further comprising:
removing a PDCP segment field by resetting a segmentation info field of the reassembled PDCP PDU; and
removing a segment sequence number (SSN) field, or
removing a segment offset (SO) field.

10. The method of claim 3 further comprising:
concatenating data field and a MAC-I field of the reassembled PDCP PDU in sequence based on a segment sequence number (SSN) field and/or a segment offset (SO) field.

11. The method of claim 9, wherein
each of the plurality of SDU segments include a consecutively numbered segment sequence number (SSN) field; and
the plurality of SDU segments are reassembled according to the segment sequence number.

12. The method of claim 9, wherein
the plurality of SDU segments are reassembled according to a segment offset field contained within that indicates a position of the segment within an original unsegmented SDU.

13. The method of claim 9, wherein
the plurality of SDU segments are received from multiple medium access control (MAC) entities and communicated between a plurality of radio link control (RLC) entities of the receiving device and combined or concatenated in a receiving RLC entity of the receiving device;
wherein the plurality of SDU segments are combined or concatenated based on a pre-defined RLC segment length; or
the plurality of SDU segments are combined or concatenated based on: a segment offset field contained within that indicates a position of the segment within an original unsegmented SDU; or
each of the plurality of SDU segments include a consecutively numbered segment sequence number (SSN) field; and the plurality of SDU segments are combined or concatenated according to the segment sequence number.

14. The method of claim 9, wherein
the plurality of SDU segments are received from a plurality of different transmitting RLC entities of the transmitting device and combined or concatenated in a receiving RLC entity of the receiving device.

15. (canceled)

16. (canceled)

17. (canceled)

18. The method of claim 3, further comprising:
transmitting a retransmit indication to a radio link control (RLC) entity of the receiving device from a PDCP entity of the receiving device in response to unsuccessfully receiving an RLC service data unit (SDU) from the RLC entity.

19. The method of claim 9, wherein
the plurality of SDU segments are received from a plurality of different RLC entities and combined or concatenated in a receiving PDCP entity of the receiving device;
wherein the plurality of SDU segments are combined or concatenated based on a pre-defined RLC segment length; or
the plurality of SDU segments are combined or concatenated based on: a segment offset field contained within that indicates a position of the segment within an original unsegmented SDU; or
each of the plurality of SDU segments include a consecutively numbered segment sequence number (SSN) field; and the plurality of SDU segments are combined or concatenated according to the segment sequence number.

20. (canceled)

21. (canceled)

22. (canceled)

23. The method of claim 1, wherein
the SDU is an original SDU; and the method further comprises:
duplicating the original SDU; and
sending the original SDU and the duplicated SDU to a plurality of medium access control (MAC) entities corresponding to a plurality of cells of the transmitting device.

24. The method of claim 1, wherein
the SDU is an original SDU; and the method further comprises:
splitting the original SDU into a first PDCP group and a second PDCP group; and
sending the first and second PDCP groups to corresponding first and second medium access control (MAC) entities corresponding to a plurality of cells of the transmitting device.

25. The method of claim 1, wherein
the SDU is an original SDU; and the method further comprises:
duplicating the original SDU; and
sending the original SDU and the duplicated SDU to a plurality of physical (PHY) entities corresponding to a plurality of cells of the transmitting device.

26. The method of claim 1, wherein
the SDU is an original SDU; and the method further comprises:
splitting the original SDU into a first PDCP group and a second PDCP group; and
sending the first and second PDCP groups to corresponding first and second physical (PHY) entities corresponding to a plurality of cells of the transmitting device.

27. A device for wireless communication comprising:
a processor; and
a memory in communication with the processor, the memory storing a plurality of instructions executable by the processor to cause the device to:
receive a service data unit (SDU);
divide the SDU into a plurality of segments;
transmit the plurality of segments to a receiving device; and
transmit an acknowledgement of successful transmission of one or more of the plurality of segments.

28. A non-transitory computer-readable medium comprising instructions operable, when executed by one or more processors, to:
implement the method as claimed in claim 1.
